(19) United States
(12) Patent Application Publication
(10) Pub. No.: US 2005/0044266 A1
(43) Pub. Date: Feb. 24, 2005

(54) High isolation KVM switch

(75) Inventor: William O'Neil, Tewksbury, MA (US)

Correspondence Address: GREENBERG-TRAURIG, 1750 TYSONS BOULEVARD, 12TH FLOOR, MCLEAN, VA, 22102, US

(73) Assignee: DigitalNet Government Solutions, LLC, Herndon, VA (US)

(21) Appl. No.: 10/887,846

(22) Filed: Jul. 12, 2004

Related U.S. Application Data
(60) Provisional application No. 60/486,196, filed on Jul. 11, 2003.

(51) Int. Cl. G06F 15/173; H04Q 11/00; H04L 12/50

(52) U.S. Cl. 709/238; 370/360

(57) ABSTRACT

A switching system between channels from connected computers, the system comprising a signal path for each channel extending from each connected computer to a user's input and display devices, each signal path being substantially shielded and comprising a filter, a series switch connected to a resistor, and at least one shunt switch connected to a ground; and a channel selector switch receiving all of the signal paths; wherein the user selects a channel and a corresponding signal from the selected channel travels in the corresponding signal path through the filter, the series switch, and the channel selector, and wherein the signals of an unselected channel pass through the filter in the corresponding signal path to the resistor of the series switch, the signal passes through the at least one shunt switch to the ground, and the signal path of the unselected channel terminates at the channel selector.

This application claims priority from Provisional U.S. Patent Application Ser. No. 60/486,196, filed Jul. 11, 2003, which is hereby incorporated by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of switching devices, and more specifically to a keyboard, video monitor, and mouse switch for isolating signals from connected computers.

### BACKGROUND OF THE INVENTION

In the operation of connected computers, a single user typically interacts with one computer at a time. A keyboard, video monitor, and mouse (“KVM”) switch allows a single user to operate one of a plurality of computers, servers, or other sources. KVM switches are often used at sites where a plurality of computers is in continuous operation, such as a data center or a server grouping.

A user situated at a worksite, having a keyboard, video monitor, and mouse, uses the KVM switch to select a computer to access. The output of the video card of the selected computer is displayed on the video monitor. Additionally, commands from the keyboard and mouse are directed to the selected computer.

A conventional KVM switch can allow unintended electrical signals from an unselected computer to pass to the selected computer. Such leakage must be kept at a low enough level not to interfere with the operation of the selected computer so as not producing video signal distortion and other undesirable effects. However, high security environments are more concerned with preventing leakage from the selected computer to the unselected computer. These unintended electrical signals can pose a far greater hazard than simple interference. It can result in the compromise of sensitive or classified information. As a result, secure applications require a higher isolation KVM switch.

Conventional approaches to switching video signals in a KVM switch include reed relay, fiber optic isolators, or semiconductor switches. These switches are often regarded as being “ideal,” as supposedly no signal passes through the switch in its “off” state. In reality, however, some signal does pass through the switch in its “off” state, especially at higher frequencies. The isolation properties of a switch are measured by the amount of signal passed in the “off” state over a range of frequencies. In this regard, a conventional KVM switch might meet a video isolation specification of 30 to 40 dB from 0 to 100 MHz. Conventional KVM switches generally provide sufficient isolation for an interference-free display. Even though interfering video may not appear on the display under normal viewing conditions, however, interfering video signal may still be present in the video signal. Thus, while traditional KVM switches meet the performance requirements of most applications, they do not meet the electrical isolation requirements of high security environments.

### SUMMARY OF THE INVENTION

Accordingly, the present invention provides a KVM switch that provides improved electrical isolation characteristics. Some applications require a higher degree of isolation to retain information integrity than is available with traditional KVM switches. The present invention prevents any detectable remnant of keyboard, video monitor, or mouse information from passing from the selected computer to the unselected computers. Remnants include the video signal itself and any distortion products related to the video. Distortion products include harmonic frequencies of the video as well as other frequency signals produced within the computer. All these “spurious” signals can make video, keyboard, mouse, and other information available to certain detection methods. What is desired is a switch for connecting a single monitor, keyboard, and mouse to a plurality of computers with a very high level of electrical isolation between computers attached to the switch.

A KVM switch according to the present invention provides high electrical isolation between the signals in the switch, without any signal amplification or processing. Avoiding amplification is desirable to reduce complexity and distortion. Avoiding processing is desirable to remove all computing intelligence from the switch. In extreme security situations, computing intelligence can be a weakness, requiring great scrutiny before it can be trusted.

The KVM switch utilizes high-order low pass filters on all of the KVM switch inputs (all video interface signals, mouse, and keyboard, as well as dc power) to limit the signal bandwidth within the KVM switch. Two position single pole series switches are placed at the filter outputs. In the “on” position, the series switches allow filter outputs to pass through the KVM switch. In the “off” position, the series switches pass the filter outputs to a terminating 75 ohm resistor. In addition, one or more shunt switches are placed between the series switch output and the KVM output. When the series switch is in the “on” position, the shunt switches are placed in the “off” position, forming an open circuit, and the series switch output is allowed to pass to the KVM switch output. When the series switch is in the “off” position, the shunt switches are placed in the “on” position, and any signal bleeding over from the series switch is shunted to ground, thereby improving isolation. The KVM switch processes keyboard and mouse input signals through a similar switching arrangement.

RF shielding also assists in achieving high isolation. The shielding substantially encloses all the signals from each connected computer. The shielding does not extend beyond the filters and their associated switches. Continued heavy RF shielding is not necessary beyond the filters and switches because the filters and switches do such an effective job of rejecting high frequency signals. The RF shield may be a thin, sheet metal container that is designed to completely enclose all the signals that make up each computer connection. The RF shield is connected to signal ground that acts to prevent any capacitive coupling from the circuits within the shield to circuits outside the shield.

In one embodiment, a switching system between a plurality of channels from connected computers has a signal path for each channel extending from each connected computer to a user's input and display devices, a filter in the signal path for each channel, a series switch located in line after the filter and connected to a resistor, a shunt switch in the signal path for each channel also connected to a ground, and a channel selector switch receiving all of the signal paths. The user selects a channel to receive the corresponding signal path. The selected signal path passes the signal through the filter, the series switch, and the channel selector. The signal passes through a filter that may be a ninth order Butterworth filter with a cutoff frequency of 70 MHz or a seventh order Butterworth filter with a cutoff frequency of 3 MHz, depending on the signal properties. The channels that are not selected pass through their filters to a 75 ohm termination resistor after the series switch. The shunt switches pass any remaining signal in the signal path to the ground. The signal path terminates at the channel selector. Each signal path for each channel has two shunt switches. The series switch and the shunt switches in the signal path for each channel are preferably CMOS FET transistors with an “on” position impedance of about 3 to 4 ohms. Also, the filter, the series switch, and the shunt switch are shielded from the other signal paths.

Another embodiment provides a keyboard, video monitor, and mouse (KVM) switch for switching between a plurality of connected computers, each connected computer providing a signal to the KVM switch, and a user selecting one of the plurality of connected computers to send and receive signals. The KVM switch comprises a filtering device for each signal provided to the KVM switch to filter out a signal portion having a frequency higher than a predetermined passband, a plurality of switching devices, wherein a selected computer signal is passed through a switching device and any unselected computer signals are terminated at a resistor, and shunting devices to shunt unselected signals to a ground. The filtering device is a ninth order Butterworth filter with a cutoff frequency of 70 MHz or a seventh order Butterworth filter with a cutoff frequency of 3 MHz for a signal, depending upon the properties of the signal. The system further comprises two shunting switches for each signal. The switching devices and shunting devices are preferably CMOS FET transistors having an “on” position resistance of about 3 to 4 ohms. The filtering device, the plurality of switching devices, and the shunting devices are shielded from the other signals.

Yet another embodiment provides a method for isolating a signal from a connected computer for communication with a group of shared peripherals, the method comprising the steps of selecting a connected computer for communication at a channel selector; providing signals from connected computers; filtering the signal of the connected computer through a low pass filter; passing the selected signal through a series switch; passing the selected signal through a channel selector; passing an unselected signal through a series switch to a termination resistor; passing the unselected signal through a shunt switch to a ground; and passing the unselected signal to a channel selector. Further, the low pass filter, the series switch, and the shunt switch may be shielded.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description, serve to explain the principles of at least one embodiment of the invention.

In the drawings:

FIG. 1 is a schematic illustration of a system having three computers connected to a group of shared peripherals according to an embodiment of the present invention.

FIG. 2 is a schematic illustration of a switching arrangement as implemented in an embodiment of the invention.

### DETAILED DESCRIPTION OF THE PREFERRED EMBODIMENT

Reference will now be made in detail to the preferred embodiments of the present invention, examples of which are illustrated in the accompanying drawings.

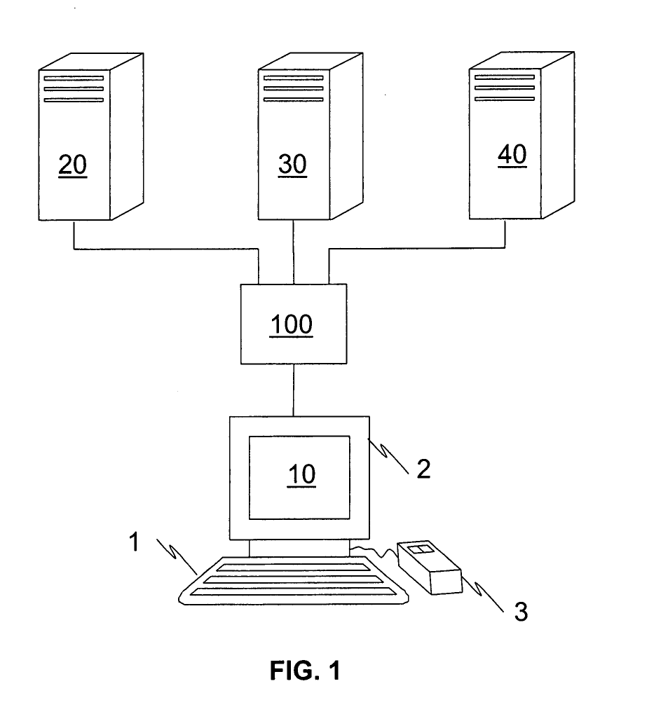

Referring to FIG. 1, an embodiment of the switching system is shown. A user operates a group of shared peripherals 10, which includes a keyboard 1, a video monitor 2, and a mouse 3. Alternatively, the group of shared peripherals 10 may include any other input or display device known to one of ordinary skill in the art.

A keyboard, video monitor, and mouse (“KVM”) switch 100 is positioned between the group of shared peripherals 10 and connected computers 20, 30, 40. Although three computers are shown, any number of computers may be connected for use of the present invention. KVM switch 100 is operable by the user for selecting which connected computer 20, 30, 40 to control. The user then accesses the selected connected computer using the shared peripherals 10, including keyboard 1, video monitor 2, and mouse 3. Video signals from the selected connected computer pass through KVM switch 100 to video monitor 2. Keyboard 1 and mouse 3 input signals from the group of shared peripherals 10 pass through KVM switch 100 to the selected connected computer. KVM switch 100 provides a high degree of isolation to maintain signal integrity and security.

The KVM switch provides high electrical isolation between the critical points in the switch without signal amplification or processing. The KVM switch uses high-order low pass filters as well as series and shunt switches and RF shielding to limit crosstalk or cross-channel pickup. The KVM switch utilizes precise low pass filtering of all signal paths through the switch to reject all out-of-band energy up to 1 GHz. The high frequency design prevents any unwanted cross coupling between channels up to 1 GHz. The KVM switch has at least two very low loss series “on” elements in any through path to negate the need for any active amplification. Additionally, multiple “on” elements in shunt between the series elements further improve isolation.

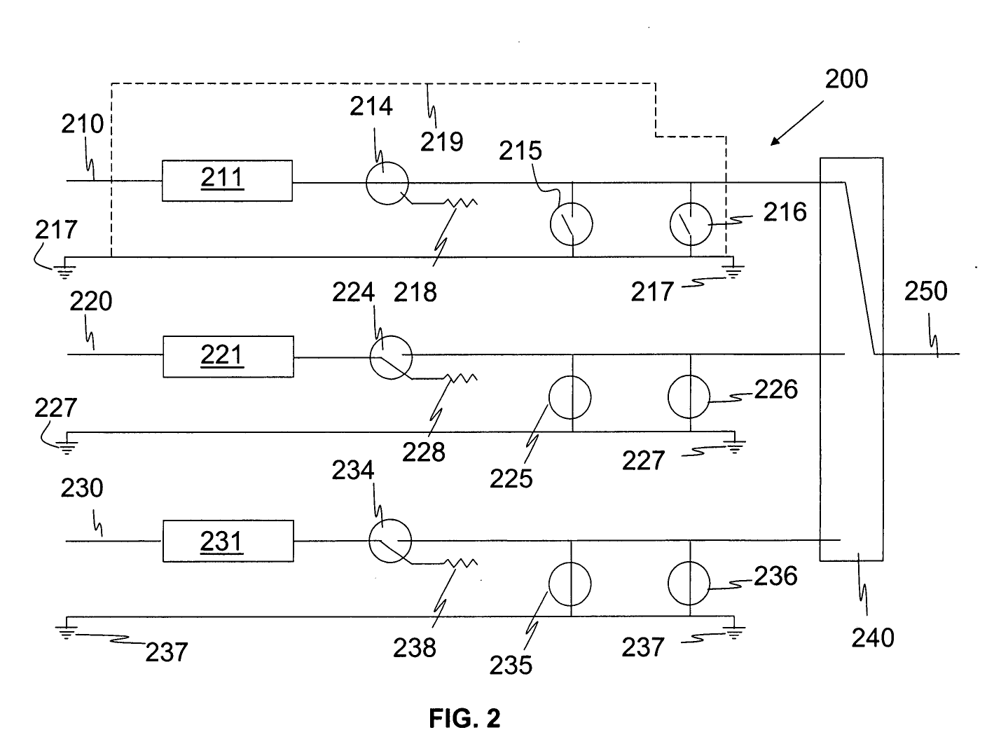

Referring to FIG. 2, a schematic illustration of a switching arrangement of a KVM switch 200 is shown. In this exemplary embodiment, three channels 210, 220, 230 are shown, although the system switch may operate with any number of inputs. A user may choose to operate any one of the three connected computers or servers connected to channels 210, 220, 230, respectively. Channels 210, 220, 230 provide a video signal path from video cards of the three computers to KVM switch 200. Upon selection of a channel, KVM switch 200 displays the video from that channel on a monitor.

Inputs from the user on a peripheral input device, such as a keyboard or mouse, are provided to the selected channel of channels 210, 220, 230. The input device signal passes through the selected channel to the corresponding computer. Accordingly, KVM switch 200 provides input and output signals between the computers and the peripherals.

Using a channel selector switch 240 on KVM switch 200, the user selects a computer to operate. In this exemplary embodiment, the user selects the computer associated with channel 210. Each channel 210, 220, 230 has a substantially similar path to channel selector switch 240. Although this exemplary embodiment describes the operation video signal path through the KVM switch, input signals also travel through KVM switch 200 through the signals paths for each channel between the peripherals and the connected computers.

The video signals of channels 210, 220, 230 are first filtered through channel filters 211, 221, 231. Channel filters 211, 221, 231 house filters for the signals. For example, the red, green, and blue signal elements of the video signal may each pass through a high order low pass filter that limits the video signal bandwidth. Channel filters 211, 221, 231 house filters for both the red, green, and blue video signals, horizontal and vertical video synchronizing signals, and the VID ID data and clock signals that collectively make up the video signal from channels 210, 220, 230 and the keyboard and mouse signals. To accommodate for all of these signals, channel filters 211, 221, 231 have a filter with a cutoff frequency sufficient for the red, green, and blue video signals and another filter with a cutoff frequency sufficient for the other video signals and the keyboard, and mouse signals. In this exemplary embodiment, each channel filter 211, 221, 231 comprises a video filter and a keyboard and mouse filter.

The video filter is preferably a ninth order Butterworth filter with a cutoff frequency of 70 MHz. The video filter filters three signals, one for the red, green, and blue, video signals respectively. The video signal sufficiently passes through the video filters. The theoretical out of band rejection is 30 dB at 100 MHz and increases at the rate of 54 dB/octave. At frequencies above 200 MHz, the attenuation of the video filter by itself sufficiently isolates the video signal. The specific order, cutoff frequency, and type of filter required varies with the signal. In particular, the cutoff frequency of the video filter would increase with increasing video resolution.

When a signal is provided from a keyboard or mouse to the selected computer, the signal similarly passes through channel filters 211, 221, 231. The signal may contain signals from the keyboard and mouse. Also the other signal elements of the video signal, namely the horizontal synch, vertical synch, and the VID ID data and clock signals pass through channel filters 211, 221, 231. Within channel filters 211, 221, and 231, these signals pass through filters, which may be seventh order Butterworth filters with a cutoff frequency of 3 MHz. The signals have much lower bandwidths and contain much less spurious high frequency content. At frequencies above 100 MHz, the filters provide the needed isolation. The specific order, cutoff frequency, and type of filter may be varied by one of ordinary skill in the art.

The filters function sufficiently in a range up to 1 GHz. The miniature surface mount device (“SMD”) coils and capacitors readily available combined with the latest SMD manufacturing technologies permit low cost, high performance filters to be added to the KVM Switch. SMD technology is more compact and has less stray inductance and capacitance than conventional devices.

RF shielding substantially encloses each channel to improve isolation of these compact circuits. The RF shield may be a thin, sheet metal container that is designed to completely enclose all the signals that make up each computer connection. In FIG. 2, a line representing shielding 219 is shown for channel 210. Shielding for channels 220, 230 are not shown, but is substantially similar in configuration for each channel. Shielding 219 is connected to ground 217 and encloses the filters and switches of channel 210. Connecting the RF shield to signal ground acts to prevent any capacitive coupling from the circuits within the shield to circuits outside the shield. Continued heavy RF shielding is not necessary beyond the filters and switches because the filters and switches do such an effective job of rejecting high frequency signals.

After the video signal is filtered through channel filter 211, 221, 231, the video signal proceeds to series switches 214, 224, 234 in each signal path. Each series switches 214, 224, 234 is a two position single pole series switch. In this exemplary embodiment where channel 210 corresponds to the selected computer, series switch 214 is in an “on” position and series switches 224, 234 are in an “off” position. In the “on” position, series switch 214 allows the filtered video signal to pass through. In the “off” position, series switches 224, 234 pass the filtered video signal to a resistor 218, 228, 238, effectively ending the signal in KVM switch 200. Resistor 218, 228, 238 may be a 75 ohm termination resistor, or other resistor known in the art for substantially terminating the signal.

After the video signal passes through series switches 214, 224, 234, the signal path continues to at least one “shunt switch.” In the exemplary embodiment, two shunt switches 215, 216, 225, 226, 235, 236 are positioned within the path for each channel 210, 220, 230. However, more shunt switches may be utilized to increase isolation. Shunt switches 215, 216, 225, 226, 235, 236 are placed in parallel between series switches 214, 224, 234 and a ground 217, 227, 237. When series switch 214, 224, 234 is placed in the “on” position for a channel, the corresponding shunt switches 215, 216, 225, 226, 235, 236 in the same channel path are placed in the “off” position. This forms an open circuit and video signal output from series switch 214, 224, 234 passes to an output 250 of KVM switch 200. When a series switch 214, 224, 234 is placed in the “off” position, the corresponding shunt switches 215, 216, 225, 226, 235, 236 in the same channel path are placed in the “on” position. This forms a closed circuit and any signal bleeding over from series switches 214, 224, 234 is shunted to ground 217, 227, 237, thereby improving isolation. Thus, the channels that are not selected have the signal shunted to ground to further reduce leakage to a selected channel.

Series and shunt switches 214, 224, 234, 215, 216, 225, 226, 235, 236 are generally not well behaved at higher frequencies. Ideally, the switch elements have zero resistance in the “on” position. In reality, however, the switch elements have a very small resistance.

After shunt switches 214, 224, 234, 215, 216, 225, 226, 235, 236, the signal passes through channel selector switch 240. Channel selector switch 240 is a single pole four position switch operated by the user to allow the output of the selected channel. The selected signal then passes through output 250 to the shared peripherals.

In this exemplary embodiment, each of the switch elements is a CMOS FET transistor with very low resistance in the “on” position and very low capacitance in the “off” position. In one embodiment, the resistance in the “on” position is about 3 to 4 ohms. A signal passing through a selected channel passes through two FET transistors in the “on” position, totaling about 6 to 8 ohms. This resistance introduces about 0.5 dB loss in the video signal. The low loss negates the need for any additional amplification. The absence of amplification simplifies the KVM switch. Amplification of the signal adds noise and distortion to the signal. The KVM switch is considered passive with the FET devices acting as on/off switches.

The KVM switch provides a high degree of isolation between critical points in the switch. In one embodiment, the KVM switch delivers signal isolation of about 60 to 80 dB from 0 to 1000 MHz. The high isolation requirement applies not only to the normal video frequency band, but also extends substantially above the video band, e.g., up to 1 GHz.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

1. A keyboard, video monitor, and mouse (KVM) switch for switching between a plurality of connected computers, each connected computer providing a signal to the KVM switch, and a user selecting one of the plurality of connected computers to send and receive signals, the KVM switch comprising:
a filtering device for each signal provided to the KVM switch to filter out a signal portion having a frequency higher than a predetermined passband;
a plurality of switching devices, wherein a selected computer signal is passed through one switching device and an unselected computer signal is terminated at a resistor; and
a plurality of shunting devices, wherein unselected computer signals are shunted to a ground.

2. The system of claim 1, wherein the resistor is a 75 ohm resistor.

3. The system of claim 1, wherein the filtering device is a ninth order Butterworth filter with a cutoff frequency of 70 MHz.

4. The system of claim 1, wherein the filtering device is a seventh order Butterworth filter with a cutoff frequency of 3 MHz.

5. The system of claim 1, wherein the system comprises two shunting devices for each signal.

6. The system of claim 1, wherein the switching devices and shunting devices are CMOS FET transistors.

7. The system of claim 6, wherein the CMOS FET transistor has an “on” position resistance of about 3 to 4 ohms.

8. The system of claim 1, further comprising a shield for each signal substantially enclosing the filtering device, the plurality of switching devices, and the plurality of shunting devices.

9. A switching system between a plurality of channels from connected computers, the system comprising:
a signal path for each channel extending from each connected computer to a user's input and display devices, each signal path comprising:
a filter;
a series switch located in line after the filter and connected to a resistor; and
at least one shunt switch connected to a ground;
+P2
a channel selector switch receiving all of the signal paths;
wherein the user selects a channel that passes a signal in the corresponding signal path through the filter, the series switch, and the channel selector, and wherein the signals of an unselected channel pass through the filter in the corresponding signal path to the resistor of the series switch, the signal path passes the unselected channel signal through the at least one shunt switch to the ground, and the signal path of the unselected channel terminates at the channel selector.

10. The system of claim 9, wherein the resistor is a 75 ohm resistor.

11. The system of claim 9, wherein the filter in the signal path for each channel is a ninth order Butterworth filter with a cutoff frequency of 70 MHz.

12. The system of claim 9, wherein the filter in the signal path for each channel is a seventh order Butterworth filter with a cutoff frequency of 3 MHz.

13. The system of claim 9, wherein each signal path for each channel has two shunt switches.

14. The system of claim 9, wherein the series switch and the at least one shunt switch in the signal path for each channel are CMOS FET transistors.

15. The system of claim 14, wherein the CMOS FET transistor has an “on” position resistance of about 3 to 4 ohms.

16. The system of claim 9, further comprising a shield for the signal of each channel substantially enclosing the filter, the series switch, and the least one shunt switch.

17. A method for isolating a signal from a computer for communication with a group of shared peripherals, the method comprising the steps of:
selecting a computer for communication at a channel selector;
providing signals from a plurality of connected computers;
filtering the signal of the connected computer through a low pass filter;
passing the selected signal through a series switch;
passing the selected signal through a channel selector;
passing an unselected signal through a series switch to a termination resistor;
passing the unselected signal through at least one shunt switch to a ground; and
passing the unselected signal to a channel selector.

18. The method of claim 17, further comprising the step of shielding the low pass filter, the series switch, and the least one shunt switch for each signal.
